(19) United States
(12) Patent Application Publication
(10) Pub. No.: US 2026/0015774 A1
(43) Pub. Date: Jan. 15, 2026

(54) PRECURSOR FIBERS OF LIGNIN-BASED CARBON FIBERS, THEIR PRODUCTION AND USE

(71) Applicant: Technikum Laubholz GmbH, Göppingen (DE)

(72) Inventors: Erik FRANK, Dornstadt (DE); Philipp KREIS, Altbach (DE); Michael R. BUCHMEISER, Remshalden (DE)

(21) Appl. No.: 18/993,686

(22) PCT Filed: Jul. 14, 2023
(86) PCT No.: PCT/EP2023/069637

§ 371 Date: Jan. 13, 2025

(30) Foreign Application Priority Data
Jul. 14, 2022 (DE) 10 2022 117 670.3

(51) Int. Cl. D01F 9/00; C01B 32/205; C08L 97/00; D01D 1/02; D01D 5/04; D01F 6/20; D01F 9/17; D01F 9/21

(52) U.S. Cl. CPC D01F 9/00; C01B 32/205; C08L 97/005; D01D 1/02; D01D 5/04; D01F 6/20; D01F 9/17; D01F 9/21; C01P 2006/21; C08L 2201/54; C08L 2203/12; C08L 2312/00; D10B 2101/12; D10B 2321/12

(57) ABSTRACT

Described are precursor fibers of lignin-based carbon fibers with a content of water-soluble lignin salt (A). A special characteristic of these precursor fibers is the inclusion of water-soluble polyvinylpyrrolidone or a derivative (B) thereof. Further described is an advantageous process for producing these precursor fibers as well as their advantageous use for producing carbon fibers by carbonization, optionally followed by graphitization.

The invention relates to a process for the production and use of precursor fibers of lignin dry-spun from water, which can subsequently be converted into carbon fibers.

Carbon fibers in the form of fiber composites combine excellent mechanical properties with low density, which leads to a high energy-saving potential. A large part of the carbon fibers produced are based on polyacrylonitrile (PAN) (>95%), which is produced by polymerizing acrylonitrile with a small proportion of comonomers. The required acrylonitrile is synthesized from petroleum-derived propene with ammonia. The precursor fiber is produced using a special wet spinning process. Due to the high costs of the energy-intensive production of carbon fibers, the poor CO₂ balance of the overall process, and the use of problematic toxic solvents in the wet spinning process, alternative materials and processes have long been sought.

Lignin has long been investigated as a possible alternative for PAN-based carbon fibers. A decisive factor for this investigation were the 50 million tons of lignin produced annually as a by-product of paper production and in biorefineries. After cellulose, lignin is the second most common biopolymer found in nature. While around 2% of the lignin is used for commercial applications, the majority is merely used as fuel.

Apart from its economic importance, lignin has a high carbon yield during carbonization (Fang et al., Manufacture and application of lignin-based carbon fibers (LCFs) and lignin-based carbon nanofibers (LCNFs), Journal of Green Chemistry, 2017, pp. 1794-1827). Nevertheless, the use of lignin as a precursor material is associated with some difficulties due to its chemical composition, structure, and purity. Lignin is differentiated into organosolv, kraft, soda lignin, and lignosulfonate by the various digestion processes. The lignosulfonate is obtained as a by-product in a sulfite process during the production of chemical pulp. In this process, the free hydroxyl groups of the lignin are replaced by sulfonate groups. Thus, lignin becomes water-soluble and can therefore be used for the water-based dry spinning process. The sulfite process can be used to produce lignosulfonates with weight-average molecular weights of up to several 10,000 g/mol, as sulfite digestion is usually carried out in an acidic environment, and therefore the β-O-4 bonds in the lignin are not broken.

The first processes for the production of carbonized lignin fibers were disclosed as early as 1960 in U.S. Pat. No. 3,461,082 A (Otani et al.). The lignin fibers mentioned therein could be produced using melt spinning, dry spinning, and wet spinning processes. In the dry spinning process, alkali lignin, thiolignin or lignin sulfonate are dissolved in a solvent such as water, alkaline sodium and potassium hydroxide solution, acidic sulfuric acid, or hydrochloric acid solution. By adding polyvinyl alcohol, PAN or viscose as a plasticizer, it was possible to spin the lignosulfonate. Y. Fukuoka of the Nippon Kayaku Co. were the first to report on commercial lignin-based carbon fibers, which were marketed under the name “Kayacarbon” (see. U.S. Pat. No. 3,461,082 A). DE 2118488 A and U.S. Pat. No. 3,723,609 A describe other methods of co-spinning lignosulfonate with polyethylene oxide or acrylic acid-acrylamide copolymers as additives, in which fibers with a tensile strength of 0.8 GPa were achieved. Zhang et al, “Carbon”, 2014, pp. 626-629, and “Journal of Applied Polymer Science”, 2016, pp. 43663 (1-10), investigated the dry spinning of acetylated softwood kraft lignin with acetone and the influence of processing temperature and spinning concentration on the processability of the fiber. The microscopic examinations showed that the fiber surfaces had notches and did not exhibit a uniform, round cross-section. This could be explained by the rapid evaporation of the acetone. The fibers produced had a strength of 1.04 GPa and a modulus of elasticity of 52 GPa. Since fusion of the fibers was only prevented by a low heating rate of 0.01° C./min, this process was not suitable for large-scale production. Additional UV irradiation of the lignin fibers reduced the stabilization time from 40 h to 4 h (see Zhang et al, Carbon Fibers from UV-Assisted Stabilization of Lignin-Based Precursors, “Fibers”, 2015, pp. 185-194). However, the mechanical properties deteriorated (tensile strength of 900 MPa and modulus of elasticity of 34 GPa).

Jin et al. (Carbon Fibers Derived from Fractionated-Solvated Lignin Precursors for Enhanced Mechanical Performance, ACS Sustainable “Chemistry & Engineering”, 2018, pp. 14135-14142) reported on a fractionated lignin from softwood kraft lignin with a weight-average molecular weight of 28,600 g/mol, which was dry-spun into fibers with a mixture of 85% acetic acid and 15% water. The winding speed in the process was between 20 and 30 m/min. The fibers had a strength of 1.39 GPa and a modulus of elasticity of 98 GPa.

In the 1990s, low-cost lignin fibers were already obtained using simple melt spinning processes (Kubo et al., “Journal of Polymers and the Environment”, 2005. pp. 97-105; Alexy et al, “Polymer”, 2000, pp. 4901-4908). As things currently stand, a plurality of patents and publications on the production of lignin-based carbon fibers exist. The melt spinning process does have some advantages over the dry spinning process indeed, such as the absence of solvents and the fast take-off speed. However, due to its amorphous and branched structure, lignin has no melting point and therefore tends to decompose (see Jin et al, “Chemistry & Engineering”, 2018, pp. 14135-14142). Furthermore, the amorphous structure prevents a crystalline orientation of the fiber, which can have a negative effect on the mechanical properties. As a result, lignin is chemically modified or spun using additional polymers in the melt spinning process to counteract its poor spinnability. To date, there is no commercially available lignin-based carbon fiber that meets the current requirements.

CN 111321487 A describes a process for producing carbon nanofibers using an electrospinning process. These carbon nanofibers are supposed to have graphene structures on the surface and be suitable for applications in the fields of energy storage, catalysis, and adsorption. In the examples of CN 111321487 A, carbon nanofibers are produced from a mixture of lignosulfonate and polyvinyl alcohol.

Based on the above prior art, the object of the invention is to propose advantageous precursor fibers of lignin-based carbon fibers which eliminate the disadvantages described in connection with the above prior art, wherein this is supposed to be achieved by an advantageous dry spinning process, whereby water-based, dry-spun lignin fibers are obtained accordingly. These in turn should be advantageously convertible into carbon fibers, combined with a high carbon yield, low porosity, and improved mechanical properties, in particular better values for tensile strength and modulus of elasticity.

The aim of the present invention is therefore also to obtain carbon fibers with excellent properties in terms of strength and modulus of elasticity from the dry-spun precursor fibers obtained by a beneficial process.

The invention solves this problem be means of precursor fibers for lignin-based carbon fibers with a content of water-soluble lignin salt (A) and a water-soluble polyvinylpyrrolidone or derivative thereof (B).

Advantageous embodiments of these precursor fibers can be described as follows:

It is advantageous if the water-soluble lignin salt (A) is represented by the formula L-R_{z} (I), wherein the moiety -R_{z} represents a sulfonate, phosphate, phosphonate, phosphinate, phosphite, phosphonite, and/or a phosphinite moiety, wherein the water-soluble lignin salt (A) particularly is lignin sulfonate. It has proven to be advantageous if the cation in the water-soluble lignin salt (A) is a sodium, ammonium, calcium, and/or magnesium ion, in particular an ammonium ion.

It is also important to pay attention to the weight average molecular weight M_{w} of the water-soluble lignin salt (A). It is useful if the water-soluble lignin salt (A) has a weight-average molecular weight M_{w} of about 5,000 to 1,000,000, in particular of about 10,000 to 800,000 g/mol, and/or the water-soluble polyvinylpyrrolidone or derivative thereof (B) has a weight-average molecular weight M_{w} of about 10,000 to 2,000,000 g/mol, in particular of about 50,000 to 100,000 g/mol. In the context of the invention described here, the molecular weight is to be determined using GPC and suitable standards (e.g. polystyrene).

In the practical exercise of the present invention, it has been found that the water-soluble polyvinylpyrrolidone is conveniently present as a homopolymer. It may also be a derivative, in particular a copolymer, wherein the derivative of polyvinylpyrrolidone should essentially correspond to it in terms of its physical properties, that is, not only with regard to the above-mentioned general conditions for the weight average molecular weight Mw, but in particular with regard to the other physical quantities specified in detail below. Suitable copolymers are: Poly-(1-vinylpyrrolidone-co-vinylacetate) and poly-(N-vinylcaprolactam-co-N-vinylpyrrolidone). The comonomers are present in the copolymer of the polyvinylpyrrolidone in a molar amount, expressed as mol %, of from 0.1 to 40 mol %, in particular from 10 to 30 mol %.

It is particularly preferable, if the water-soluble polyvinylpyrrolidone or derivative thereof (B) has a softening point of about 100° C. to 175° C., in particular about 140° C. to 160° C.

Particularly advantageous effects are achieved with the precursor fibers according to the invention if these contain a water-soluble, thermally activatable crosslinking agent (C) in the form of a formaldehyde-releasing compound. It is considered advantageous if the thermally activatable crosslinking agent (C) is present as 1,3,5-trioxane, paraformaldehyde, hexamethylenetetramine, dimethylol dihydroxyethylene urea (DMDHEU), 1,3-bis(hydroxymethyl) imidazolidin-2-one (DMEU), and/or 1,3-bis(hydroxymethyl) urea (DMU).

In an advantageous embodiment of the precursor fibers according to the invention, about 0.1 to 1 part by weight, in particular about 0.3 to 0.7 parts by weight, of a water-soluble polyvinylpyrrolidone or derivative thereof (B) are present in the precursor fibers for 1 part by weight of water-soluble lignin salt (A). An advantageous quantitative relationship is that about 0.01 to 0.3 parts by weight, in particular about 0.05 to 0.15 parts by weight, of a water-soluble crosslinking agent (C) are present in the precursor fibers for 1 part by weight of water-soluble lignin salt (A).

The process described below for producing the precursor fibers according to the invention also falls within the scope of the invention:

Accordingly, it is also an object of the present invention to provide a process for producing precursor fibers of lignin-based carbon fibers according to at least one of the advantageous embodiments of the precursor fibers described above. This process is characterized in that an aqueous solution (D) of the water-soluble lignin salt (A) and of the water-soluble polyvinylpyrrolidone or derivative thereof (B) is prepared respectively, the resulting aqueous solution (D) is dry-spun into filaments to form precursor fibers of carbon fibers and the filaments are drawn off.

It should be emphasized that the physical properties of the components in the form of the water-soluble lignin salt (A), the water-soluble polyvinylpyrrolidone (B) and the water-soluble crosslinking agent, in particular their chemical-structural properties, described in connection with the precursor fibers also apply here.

Compared to other polymers, such as polyvinyl alcohol (see U.S. Pat. No. 3,461,082 A), the precursor fiber according to the invention can be processed at a higher heating rate in the stabilization process described in detail later, preferably between 5-20 K/min, due to the inclusion of the polyvinylpyrrolidone. The reason for this is the thermal behavior of the polyvinylpyrrolidone, in particular its glass transition temperature of 150° C. Compared to PVA, whose glass transition temperature is only approx. 85° C., higher stabilization temperatures can be used. With polyvinylpyrrolidone, the fiber can be heated to 150° C. without increasing the chain mobility in the amorphous segments of the precursor fiber. This prevents the precursor fibers from sticking together. In addition to the advantage that stable spinning solutions are obtained by employing water-soluble polyvinylpyrrolidone, this additional polymer can be dissolved at room temperature.

The present invention is not subject to any significant limitations in the selection of the respective water-soluble lignin salts (A). For this purpose, commercial water-soluble lignosulfonates, in particular ammonium, calcium, magnesium or sodium lignosulfonates, may be mainly considered, but also other soluble or dispersible water-soluble lignin salts such as phosphates, phosphonates, phosphinates, phosphites, phosphonites or phosphinites. It is advantageous if water-soluble lignosulfonates with a high molecular weight from 30,000 g/mol and a low sugar content of <10%, in particular <3%, are used. By processing water-soluble lignosulfonates with a higher molecular weight, better mechanical properties, such as strength and modulus of elasticity, are achieved.

A particularly advantageous further development of the invention is that a water-soluble crosslinking agent (C) is included into the aqueous solution (D).

The dry spinning process according to the invention can preferably be carried out as follows: In the dry spinning process, the spinning solution is pressed through defined die holes (100-200 μm diameter) using a spinning pump and dried in a spinning shaft at 40-60° C. The precursor fibers can be wound onto a bobbin using a driven winder. The fibers have an advantageous diameter in the range from about 6 μm to 60 μm, preferably 6 to 20 μm, in particular from 6 μm to 20 μm, and further preferably 6 to 13 μm, and particularly preferably 10 to 13 μm. The carbon fibers to be subsequently produced from the precursor fibers preferably have a diameter of 2 μm to 30 μm, particularly preferably a diameter of 4 μm to 8 μm.

To promote the spinning process, it is advantageous that the aqueous solution (D) is adjusted to a zero shear viscosity (measured according to DIN 53019-4) of about 50 to 800 Pa·s, preferably of about 100 to 600 Pa·s, in particular of about 150 to 350 Pa·s, measured at a temperature of 22° C.

To optimize this process, it is also useful for the aqueous solution (D) to be concentrated, in particular under vacuum, and preferably using a rotary evaporator, until the zero shear viscosity (measured according to DIN 53019-4 at a temperature of 22° C.) of about 50 to 800 Pa·s, preferably of about 100 to 600 Pa·s, in particular of about 150 to 350 Pa·s, is reached, and the resulting concentrated aqueous solution (E) is dry-spun. Preferably, concentrating of the aqueous solution (D) is carried out under a vacuum of about 10 to 80 mbar, in particular of about 45 to 75 mbar. The spinning solution should preferably be free of particles and not have a gel-like character.

It has proven to be very advantageous to prepare a mixture in which 1.) about 0.1 to 1 part by weight, in particular about 0.3 to 0.7 part by weight, of a water-soluble polyvinylpyrrolidone or a derivative thereof (B) is added to 1 part by weight of water-soluble lignin salt (A) or 2.) about 0.1 to 1 part by weight, in particular about 0.3 to 0.7 parts by weight, of the water-soluble polyvinylpyrrolidone or derivative thereof (B) and about 0.01 to 0.3 parts by weight, in particular about 0.05 to 0.15 parts by weight, of a water-soluble crosslinking agent (C) are added to 1 part by weight of water-soluble lignin salt (A), and the respective mixture is dissolved in water and converted into the aqueous solution (D).

However, it is also possible to incorporate the water-soluble crosslinking agent (C) into the aqueous solution (E) first. The indicated quantitative ratios of the water-soluble lignin salt (A), the water-soluble polyvinylpyrrolidone or derivative thereof (B) and the water-soluble crosslinking agent (C) should also be considered here. Thus, it is a particular advantage for the implementation of the present invention to incorporate the water-soluble crosslinking agent (C) into the aqueous solution (D) and/or the aqueous solution (E).

As already mentioned, it is a particular advantage for the implementation of the present invention to incorporate the water-soluble crosslinking agent (C) into the aqueous solution (D) and/or the aqueous solution (E). Optionally, the mechanical fiber properties can be improved by chemical cross-linking or by introducing additional aromatic groups. Therefore, the above-mentioned water-soluble crosslinking agents (C), such as dimethylol dihydroxyethylene urea (DMDHEU), trioxane or urotropine, can be used in particular. The water-soluble crosslinking agents (C) contain formaldehyde-releasing compounds that lead to crosslinking of the lignin when thermally activated. An essential advantage is that the water-soluble crosslinking agent (C) can already be added to the polymer-containing spinning solution and spun together with it.

Attention should be paid to an advantageous further development of the process according to the invention, in which the concentrated aqueous solution (E) is dry-spun in the spinning shaft at a temperature of about 30° C. to 100° C., in particular about 40° C. to 70° C.

The water content of the aqueous solution (D) also has an advantageous effect on the success of the process according to the invention. Here, it is preferred that the aqueous solution (D) contains at least about 40% by weight, in particular about 45 to 65% by weight, of water.

The water-soluble crosslinking agent (C) incorporated into the precursor fibers has already been discussed above. The crosslinking agent is present in an activatable form. Therefore, activation is initiated particularly advantageously if the water-soluble crosslinking agent (C) incorporated in the precursor fiber is activated by thermostabilization of the precursor fibers, in oxidative thermostabilization, at a temperature of about 100 to 400° C., in particular of about 200 to 300° C., preferably 250° C.+/−20° C. The residence times of the precursor fibers in the thermostabilization are between 10 minutes and 4 hours, preferably between 10 minutes and 60 minutes, particularly preferably between 10 minutes and 40 minutes, depending on the heating rate and the temperature profile.

A particular objective of the present invention is to produce advantageous carbon fibers from the precursor fibers described above, optionally with prior thermostabilization, in particular oxidative thermostabilization, and/or with prior stabilization with high-energy radiation, and optionally with subsequent graphitization. It is also advantageous if ultraviolet radiation (UV), vacuum ultraviolet radiation (VUV), electron radiation, X-ray radiation, plasma stabilization, and/or gamma radiation are used as high-energy radiation. Accordingly, this use teaching is attributable to the idea according to the invention.

Accordingly, in a further aspect, the present invention relates to a process for producing carbon fibers from precursor fibers as indicated above, wherein the process includes a thermostabilization, in particular an oxidative thermostabilization, and/or a stabilization with high-energy radiation, and/or a plasma stabilization, and a subsequent carbonization, optionally with a subsequent graphitization. As the high-energy radiation, ultraviolet radiation (UV), vacuum ultraviolet radiation (VUV), electron radiation, X-ray radiation, and/or gamma radiation is preferred.

Furthermore, it is advantageous for the stated process if the thermostabilization of the precursor fibers is carried out in a temperature range from 100° C. to 400° C., in particular from 200° C. to 300° C., in particular at 250° C.+/−20° C.

The carbonization of the precursor fibers according to the invention is preferably carried out at temperatures between 300° C. and 1800° C. for the purposes of the process disclosed herein, suitably under an inert gas atmosphere, and particularly preferably under a nitrogen atmosphere. For carbonization, it is also advantageous if the stabilized precursor fibers are subjected to low-temperature carbonization, in particular in a temperature range from 300° C. to 1200° C., and preferably in a range from 300° C. to 1000° C., and further preferably at 800° C.+/−50° C. Such carbonization can be carried out, for example, in a low-temperature furnace (LT furnace), wherein this carbonization preferably is carried out in an inert gas atmosphere, in particular a nitrogen atmosphere.

In a preferred embodiment, the precursor fibers are drawn in a low-temperature furnace, in particular with a drawing factor of between 1% and 35%, preferably at least 2% to 30%, particularly preferably at least 5% to 25%. In this way, a further increase in the mechanical properties of the fibers can be achieved.

Furthermore, it is advantageous if the fibers are subjected to a high-temperature carbonization following the low-temperature carbonization, with the temperature preferably being set in the range from 1200° C. to 1600° C., more preferably up to 1500° C., and even more preferably up to 1400° C.+/−50° C. The high-temperature carbonization is suitably carried out in an inert gas atmosphere.

The carbon fibers resulting from the high-temperature furnace have diameters in the range of 2 to 30 μm, with a preferred diameter of 4 to 8 μm.

For the graphitization, which is provided in the context of the process, it is preferable if it takes place in an inert gas atmosphere, in particular an argon atmosphere, at a temperature of up to a maximum of 3000° C. with hot drawing. This treatment allows the orientation of the carbon fibers, and their modulus of elasticity to be further increased by simultaneous hot drawing. The graphitization can be carried out in a graphitization furnace (ultra-high temperature furnace, UHT furnace).

In yet another aspect, the present invention relates to a use of the precursor fibers as indicated above for producing carbon fibers by carbonization, optionally with preceding thermostabilization, in particular oxidative thermostabilization, and/or with preceding stabilization with high-energy radiation, and/or plasma stabilization, optionally with subsequent graphitization.

The use of water-soluble polyvinylpyrrolidone as an auxiliary polymer not only improves spinnability, but also explicitly introduces nitrogen into the carbon fibers so that they have, analogous to carbon fibers made of polyacrylonitrile, a nitrogen-containing surface for bonding resins during the production of composite components. In the state of the art for precursor fibers made of cellulose or lignin with auxiliary polymers, such as PVA, the nitrogen atoms have to be introduced in further process steps via plasma processes or chemical functionalization. The oxidative thermostabilization generally takes place in an oxygen atmosphere up to a final temperature of 100° C. to 400° C. The heating rate is between 20 and 0.05 K/min.

As already shown, the invention is characterized by numerous advantages: Thus, the invention enables the production of multifilaments and can be transferred to industrial-scale systems. The process according to the invention is economically and ecologically practicable, with the aim of realizing environmentally friendly carbon fibers with low production costs. With regard to the production of cost-effective carbon fibers, the carbon yield after carbonization plays an important role. Therefore, it is of great interest to keep the lignin content in the precursor fiber as high as possible. The precursor fibers therefore preferably have a lignin content of at least 70% by weight, although 80% by weight has also been demonstrated. The invention thus relates to a continuous dry spinning process of preferably water-soluble lignosulfonate with polyvinylpyrrolidone, using water as a solvent.

In particular, the polyvinylpyrrolidone enables a high spinning speed in the range of at least 75 m/min to 100 m/min, as it stabilizes the rather brittle and amorphous spinning dope consisting of a lignin base. In particular, the polyvinylpyrrolidone facilitates the orientation of the lignin polymer in the fiber direction and reduces brittleness, which makes handling, in particular winding, etc. easier.

The polyvinylpyrrolidone or derivative thereof (B) added to the spinning solution also allows a very high stabilization speed of 10-20 m/min, which is not even close to the state of the art. This saves considerable amounts of energy and costs in the inventive production of carbon fibers according to the invention. The invention is explained below in more detail with reference to examples:

### EXAMPLE 1

(Preparation of a Spinning Solution with 1 Part by Weight of Ammonium Lignosulfonate (Softwood) and 0.43 Parts by Weight of Polyvinylpyrrolidone and Carrying Out a Dry Spinning Process)

To prepare the spinning solution, a mixture according to the invention was dissolved in water. 500 g of the mixture contains one part by weight (350 g) of ammonium lignosulfonate (softwood) and 0.43 parts by weight (150 g) of polyvinylpyrrolidone with a weight average molecular weight of 50,000 g/mol (PVP K30 from Sigma Aldrich), which was dissolved in 1.4 l of water with stirring. After stirring for 30 minutes at room temperature, the solution was homogenized. Possible residual particles were removed by filtration. The resulting spinning solution was concentrated in vacuo on a rotary evaporator until a zero shear viscosity of 229 Pa·s at 22° C. was obtained. The rheological measurement was carried out using a Physica MCR 301 rheometer from Anton Paar with plate-plate geometry with a plate diameter of 25 mm and a gap distance of 0.5 mm.

The dry spinning process was carried out on a pilot scale with a multi-hole nozzle. The spinneret diameter was 100 μm with 90 filaments. The screw speed was 7.6 rpm. The spinning temperature was 22° C. The fibers were air-dried in the spinning shaft at temperatures between 4° and 50° C. The fibers were wound at a winding speed of 80 m/min and stored under constant climatic conditions (23° C., 40% relative humidity). The water content of the fibers after the dry spinning process was between 8-12% by weight. The determination was carried out by Karl Fischer titration at 140° C.

### EXAMPLE 2

(Preparation of a Spinning Solution with 1 Part by Weight of Ammonium Lignosulfonate (Hardwood) and 0.43 Parts by Weight of Polyvinylpyrrolidone and Carrying Out a Dry Spinning Process)

Example 2 was carried out with the exception that an ammonium lignosulfonate (hardwood) was used instead of the ammonium lignosulfonate (softwood). Accordingly, analogous to the procedure described in Example 1, 500 g of a mixture containing one part by weight (350 g) of ammonium lignosulfonate (hardwood) and 0.43 parts by weight (150 g) of polyvinylpyrrolidone with a weight average molecular weight of 50,000 g/mol (PVP K30 from Sigma Aldrich) was mixed into 1.4 l of water. After stirring for 30 minutes at room temperature, the solution was homogenized. Possible residual particles were removed by filtration. The resulting spinning solution was concentrated in vacuo on a rotary evaporator until a zero shear viscosity of 282 Pa·s at 22° C. was obtained. The rheological measurement was carried out using a Physica MCR 301 rheometer from Anton Paar with plate-plate geometry with a plate diameter of 25 mm and a gap distance of 0.5 mm.

The dry spinning process was carried out on a pilot scale with a multi-hole nozzle. The spinneret diameter was 100 μm with 90 filaments. The screw speed was 7.6 rpm and spinning temperature was 22° C. The fibers were air-dried in the spinning shaft at temperatures between 45 and 55° C. The fibers were wound at a winding speed of 90 m/min and stored under constant climatic conditions (23° C., 40% relative humidity).

The water content of the fibers after the dry spinning process was between 8-12% by weight. The determination was carried out by Karl Fischer titration at 140° C.

### EXAMPLE 3

(Preparation of Spinning Solutions with 60-80% by Weight Lignosulfonate and 40-20% by Weight Polyvinylpyrrolidone and Carrying Out a Dry Spinning Process)

60-80% by weight lignosulfonate with 40-20% by weight polyvinylpyrrolidone were dissolved in water and concentrated using a rotary evaporator. The water content in the resulting spinning solution was 44-55% by weight with a zero shear viscosity of 170-500 Pa·s. The spinneret comprised 90 to 250 nozzle holes with a diameter of 100 μm, resulting in rovings of 90 to 250 filaments. The maximum spinning speed was between 75 and 100 m/min, wherein the spinning shaft was heated between 40° C. and 70° C. For continuous carbonization, part of the spun coils was fanned 4 times under tension control to form an assembled roving (1k filaments).

### EXAMPLE 4

(Preparation of a Spinning Solution with 1 Part by Weight of Ammonium Lignosulfonate, 0.36 Parts by Weight of Polyvinylpyrrolidone and 0.07 Parts by Weight of Crosslinking Agent (DMDHEU) and Carrying Out a Dry Spinning Process

500 g of the mixture contains one part by weight (350 g) of ammonium lignosulfonate (softwood), 0.36 parts by weight (125 g) of polyvinylpyrrolidone with a weight average molecular weight of 50,000 g/mol (PVP K30 from Sigma Aldrich) and 0.07 parts by weight (25 g) of crosslinking agent (DMDHEU), which was dissolved in 1.4 l of water with stirring. Accordingly, the process measures of Example 1 were reproduced with the following modifications, wherein the amount of polyvinylpyrrolidone was reduced from 0.43 parts by weight to 0.36 parts by weight and an additional 0.07 parts by weight of crosslinking agent (DMDHEU) were included in the aqueous solution.

After stirring for 30 minutes at room temperature, the solution was homogenized. Possible residual particles were removed by filtration. After concentration by evaporation of water in vacuo, the zero shear viscosity of the spinning solution was adjusted to 200-300 Pa·s (measured according to DIN 53019-4 at a temperature of 22° C.). The solution was spun in a dry spinning process through a multi-hole nozzle (100 μm) and wound up at 80-90 m/min.

TABLE 1
Dry spinning tests with different mixing ratios

| | Lignin content | | Proportion | | Max. |
|---|---|---|---|---|---|
| | (softwood¹, | Proportion | Crosslinking | | Winding |
| | hardwood²) | PVP | agent | η₀ | speed |
| Example | [% by weight] | [wt %] | [wt %] | [Pa*s] | [m/min] |
| 1 | 70¹ | 30 | — | 229 | 80 |
| 2 | 70² | 30 | — | 282 | 90 |
| 3 | 70¹ | 25 | 5 | 156 | 80 |
| 3 | 70² | 25 | 5 | 300 | 90 |

*Note:
η₀ zero shear viscosity

### EXAMPLE 5: (PRODUCTION OF CARBON FIBERS: DISCONTINUOUS)

The precursor fibers obtained according to examples 1 to 3 above were stabilized discontinuously in a muffle furnace up to 250° C. The heating rate was varied between 0.5 K/min and 20 K/min, wherein the fibers did not stick together even at 20 K/min.

The tensile strength and modulus of elasticity of the precursor fibers were determined using a Favimat from the Textechno Company. For this purpose, individual filaments with a clamping length of 12 mm were clamped between two clamps and their fineness was determined by measuring the resonance frequency. The test speed of the measurement was 1 mm/min. At least 20 valid measurements were used to calculate the mean values. The fiber diameter of the individual filaments was determined using a scanning electron microscope (SEM).

The stabilized precursor fibers had a tensile strength of 8-10 cN/tex and a modulus of elasticity of 400 cN/tex.

The subsequent carbonization was carried out discontinuously in a batch furnace between 1000° C. and 1400° C. under a nitrogen atmosphere. The heating rate was 10 K/min. The carbonized fibers had a diameter of between 10-14 μm (SEM images). After cooling, carbon fibers with a carbon yield of 45% were present. The following table 2 shows exemplarily some of the carbon fiber values achieved. In the case of a continuous carbonization, it may be assumed that the mechanical parameters are significantly higher, as a drawing of the precursor is only possible then.

TABLE 2
The mechanical properties after carbonization at 1400° C.

| | | Diameter | Elongation | Strength | E modulus |
|---|---|---|---|---|---|
| Example | Mixing ratio | [μm] | [%] | [GPa] | [GPa] |
| 1 | Lignosulfonate | 17.0 ± 1.6 | 1.3 ± 0.1 | 0.98 ± 0.2 | 84 ± 18 |
| | (softwood) & PVP | | | | |
| | (70:30) | | | | |
| 2 | Lignosulfonate | 10.1 ± 1.0 | 2.4 ± 0.5 | 0.97 ± 0.2 | 41 ± 3 |
| | (hardwood) & PVP | | | | |
| | (70:30) | | | | |
| 3 | Lignosulfonate | 12.7 ± 2.0 | 2.1 ± 0.3 | 1.5 ± 0.3 | 75 ± 16 |
| | (softwood) & PVP & | | | | |
| | DMDHEU (70:25:5) | | | | |
| 4 | Lignosulfonate | 14.1 ± 2.0 | 1.8 ± 0.3 | 1.39 ± 0.24 | 81 ± 19 |
| | (hardwood) & PVP & | | | | |
| | DMDHEU (70:25:5) | | | | |

### EXAMPLE 6

Firstly, the precursor fibers obtained according to the above example 3 were fanned into a 1k roving in a stress-controlled manner and then stabilized discontinuously in a muffle furnace up to 250° C. A heating rate of 1 K/min was used with a dwelling time of 4 hours.

The subsequent continuous carbonization was carried out in the LT furnace in a temperature range between 300° C. and 750° C. and in the HT furnace up to different final carbonization temperatures in a nitrogen atmosphere.

The mechanical parameters of individual carbon fiber monofilaments, produced in a continuous carbonization process at different maximum temperatures in a high-temperature furnace 1000° C. to 1600° C., are shown in the following table. It can be seen that the highest tensile strengths could be realized in a range between 1200-1600° C., and the optimum is at 1400° C.

TABLE 3
Mechanical properties after continuous carbonization
at different maximum temperatures in the HT furnace.

| T- HT max [° C.] | 1000 | 1200 | 1400 | 1500 | 1600 |
|---|---|---|---|---|---|
| Tensile strength [GPa] | 0.7 ± 0.2 | 0.96 ± 0.2 | 1.0 ± 0.3 | 0.99 ± 0.3 | 0.8 ± 0.2 |
| Module E1 [GPa] | 55 ± 12 | 68 ± 12 | 74 ± 20 | 66 ± 23 | 47 ± 10 |
| Elongation [%] | 1.2 ± 0.3 | 1.5 ± 0.2 | 1.4 ± 0.4 | 1.6 ± 0.4 | 1.8 ± 0.4 |
| fineness [dtex] | 2.4 ± 0.5 | 2.0 ± 0.2 | 2.0 ± 0.4 | 1.8 ± 0.3 | 2.1 ± 0.3 |
| Measured values | 30 | 30 | 30 | 30 | 30 |

The intensity ratio (ID/IG) of the defect band (D1 band, 1340 cm 1) and the graphite band (G band, 1590 cm-1), which were determined by Raman spectroscopy, depend on the carbonization temperature and provide information about defects in the graphite structure. The lower the ID/IG ratio, the lower is the number of defects in the carbon structure. As the maximum carbonization temperature (coking temperature) increases, the ID/IG ratio decreases from 9.5 to 2.3 (−76%), as shown in Table 4. The spectra and data were determined and calculated from carbon fibers produced at different maximum temperatures of 1000° C. to 1600° C. in the high-temperature furnace.

TABLE 4
ID/IG values of carbon fibers produced by continuous carbonization
at different maximum carbonization temperatures.

| | Maximum | |
|---|---|---|
| Sample-ID | temperature [° C.] | I_{D}/I_{G} |
| CF1000 | 1000 | 9.5 |
| CF1200 | 1200 | 4.0 |
| CF1400 | 1400 | 3.3 |
| CF1600 | 1600 | 2.3 |

### EXAMPLE 7

(Continuous Production of Carbon Fibers with Different Draw Factors)

Analogous to the processes described above (example 3), fibers (60% by weight lignosulfonate hardwood/40% by weight PVP) were spun with 250 filaments and fanned into a 1K roving, and stabilized in a drying chamber up to 250° C. at 1 K/min (dwelling time 4 h). The fibers were then wound onto bobbins, and carbonized with a draw factor of 1% and 5% in the LT furnace (300° C. to 750° C.). Table 6 summarizes the mechanical properties of the fibers. Here, an increase in the draw factor leads to an increase of fiber values. At an elongation of 5%, the mean value of the tensile strength was 1.4 GPa, the E1 modulus 104 GPa and the elongation 1.3%.

TABLE 5
Mechanical properties after continuous carbonization
at different drawing rates:

| Drawing | 0% | 1% | 5% |
|---|---|---|---|
| T-profile LT [° C.] | 300-750 | 300-750 | 300-750 |
| T-profile HT max. [° C.] | 1400 | 1400 | 1400 |
| v (master) [m/min] | 0.4 | 0.4 | 0.4 |
| Tensile strength [GPa] | 1.0 ± 0.3 | 1.2 ± 0.3 | 1.4 ± 0.3 |
| Tensile strength [GPa]-MAX- | 1.5 | 1.6 | 2.0 |
| Module E1 [GPa] | 74 ± 20 | 82 ± 6 | 104 ± 17 |
| Module E1 [GPa]-MAX- | 123 | 110 | 165 |
| Elongation [%] | 1.42 ± 0.4 | 1.46 ± 0.4 | 1.3 ± 0.2 |
| Fineness [dtex] | 2.0 ± 0.35 | 1.38 ± 0.24 | 1.48 ± 0.33 |

The crystallite dimensions (Lₐ, L_{c}), the layer plane spacing (d₀₀₂), and the number of stacked layers (N_{c}), which were determined and calculated by means of wide-angle X-ray scattering (WAXS) of the corresponding carbon fibers having different drawing factors at 1400° C., are shown in Table 7 below. It can be seen that the crystallite dimensions Lₐ and L_{c} increase due to a drawing of 5%, the crystallites grow, while the layer plane distance d₀₀₂ decreases. The increase in orientation, which goes hand in hand with the increase in the drawing factor, is particularly advantageous.

TABLE 7
WAXS measurement or the orientation of the lignin-
based CF with a drawing factor of 0-5%:

| | maximum | | | | | | |
|---|---|---|---|---|---|---|---|
| Sample | temperature | | Lₐ | L_{c} | d₀₀₂ | | P.O. |
| ID | [° C.] | DR | [nm] | [nm] | [nm] | N_{c} | [%] |
| CF1400 | 1400 | 1.00 | 3.49 | 0.79 | 0.375 | 3.7 | — |
| CF1400.2 | 1400 | 1.01 | 3.49 | 0.79 | 0.374 | 3.7 | 53 |
| CF1400.3 | 1400 | 1.05 | 3.83 | 0.82 | 0.371 | 3.7 | 61 |

Furthermore, two-dimensional wide-angle X-ray scattering images of the carbon fibers with different drawing factors were taken. It can be seen that the higher the drawing at 1400° C., the more pronounced is the crescent shape.

### EXAMPLE 8

(Comparative Example/Spinning Solution with Pure Lignosulfonate without Polyvinylpyrrolidone)

500 g of ammonium lignosulfonate (softwood) were dissolved in 1.4 l of water. After stirring for 30 minutes at room temperature, the solution was homogenized. Possible residual particles were removed by filtration. After concentration by evaporation of water in vacuo, the viscosity of the spinning solution was adjusted. The spinning solution could not be spun because there was no sufficient thread drawing capacity.

1. Precursor fibers of lignin-based carbon fibers having a content of water-soluble lignin salt (A) and a water-soluble polyvinylpyrrolidone or derivative thereof (B).

2. Precursor fibers according to claim 1, characterized in that the water-soluble lignin salt (A) is represented by the formula L-R_{z} (I), wherein the moiety -R_{z} represents a sulfonate, phosphate, phosphonate, phosphinate, phosphite, phosphonite, and/or a phosphinite moiety.

3. Precursor fibers according to claim 2, characterized in that the water-soluble lignin salt (A) is present as lignosulfonate.

4. Precursor fibers according to claim 1, characterized in that the cation in the water-soluble lignin salt (A) is a sodium, ammonium, calcium, and/or magnesium ion, and/or an ammonium ion.

5. Precursor fibers according to claim 1, characterized in that the water-soluble lignin salt (A) has a weight-average molecular weight M_{w} of about 5,000 to 1,000,000, and/or the water-soluble polyvinylpyrrolidone or derivative thereof (B) has a weight-average molecular weight M_{w} of about 10,000 to 2,000,000 g/mol.

6. Precursor fibers according to claim 1, characterized in that the water-soluble polyvinylpyrrolidone is present as a homopolymer.

7. Precursor fibers according to claim 1, characterized in that the water-soluble polyvinylpyrrolidone or derivative thereof (B) has a softening point of about 100° C. to 175° C.

8. Precursor fibers according to claim 1, characterized in that the precursor fibers contain a water-soluble, thermally activatable crosslinking agent (C) in the form of a formaldehyde-releasing compound.

9. Precursor fibers according to claim 8, characterized in that the thermally activatable crosslinking agent (C) is present as 1,3,5-trioxane, paraformaldehyde, hexamethylenetetramine, dimethylol dihydroxyethylene urea (DMDHEU), 1,3-bis(hydroxymethyl) imidazolidin-2-one (DMEU), and/or 1,3-bis(hydroxymethyl) urea (DMU).

10. Precursor fibers according to claim 1, characterized in that for 1 part by weight of water-soluble lignin salt (A), about 0.1 to 1 part by weight, of the water-soluble polyvinylpyrrolidone or derivative thereof (B) are present in the precursor fibers.

11. Precursor fibers according to claim 8, characterized in that for 1 part by weight of water-soluble lignin salt (A) about 0.01 to 0.3 parts by weight of water-soluble crosslinking agent (C) are present.

12. A process for producing precursor fibers of lignin-based carbon fibers according to claim 1, characterized in that an aqueous solution (D) of the water-soluble lignin salt (A) and of the water-soluble polyvinylpyrrolidone or derivative thereof (B) is prepared respectively, the resulting aqueous solution (D) is dry-spun into filaments to form precursor fibers for carbon fibers, and the filaments are drawn off.

13. The process according to claim 12, characterized in that a water-soluble crosslinking agent (C) is included into the aqueous solution (D).

14. The process according to claim 12, characterized in that the aqueous solution (D) is adjusted to a zero shear viscosity (measured according to DIN 53019-4 at a temperature of 22° C.) of about 50 to 800 Pa·s.

15. The process according to claim 14, characterized in that the aqueous solution (D) is concentrated, in particular in vacuo, to raise the zero shear viscosity until the zero shear viscosity (measured according to DIN 53019-4 at a temperature of 22° C.) of about 50 to 800 Pa·s is reached and the concentrated aqueous solution (E) is dry-spun.

16. The process according to claim 12, characterized in that a mixture is prepared in which 1.) about 0.1 to 1 part by weight, in particular about 0.3 to 0.7 part by weight, of a water-soluble polyvinylpyrrolidone or a derivative thereof (B) is added to 1 part by weight of water-soluble lignin salt (A) or 2.) about 0.1 to 1 part by weight, in particular about 0.3 to 0.7 parts by weight, of the water-soluble polyvinylpyrrolidone or derivative thereof (B) and about 0.01 to 0.3 parts by weight, in particular about 0.05 to 0.15 parts by weight, of a water-soluble crosslinking agent (C) are added to 1 part by weight of water-soluble lignin salt (A), and the respective mixture is dissolved in water and transferred to the aqueous solution (D).

17. The process according to claim 15, characterized in that concentrating the aqueous solution (D) is carried out under a vacuum of about 10 to 80 mbar, in particular of about 45 to 75 mbar.

18. The process according to claim 16, characterized in that the concentrated aqueous solution (E) is dry-spun in the spinning shaft at a temperature of about 30° C. to 100° C.

19. The process according to claim 12, characterized in that the aqueous solution (D) contains at least about 40% by weight of water.

20. The process according to claim 12, characterized in that the water-soluble crosslinking agent (C) incorporated in the precursor fiber is activated by thermostabilization of the precursor fibers, in particular by oxidative thermostabilization, at a temperature of about 100 to 400° C.

21. A process for producing carbon fibers from precursor fibers according to claim 1, characterized in that for producing the carbon fibers, a thermostabilization, in particular an oxidative thermostabilization, and/or a stabilization with high-energy radiation, and/or a plasma stabilization is carried out, and a subsequent carbonization, optionally with subsequent graphitization, is performed.

22. (canceled)

23. (canceled)

24. (canceled)

25. (canceled)

26. (canceled)

27. (canceled)

28. (canceled)
